(19) United States
(12) Patent Application Publication
(10) Pub. No.: US 2026/0139966 A1
(43) Pub. Date: May 21, 2026

(54) MAP GENERATION DEVICE, MAP GENERATION METHOD, AND MAP GENERATION PROGRAM PRODUCT

(71) Applicants: DENSO CORPORATION, Kariya-city (JP); J-QuAD DYNAMICS Inc., Tokyo (JP)

(72) Inventors: YUSUKE MATSUMOTO, Tokyo (JP); CHAO CHEN, Tokyo (JP)

(21) Appl. No.: 19/387,236

(22) Filed: Nov. 12, 2025

(30) Foreign Application Priority Data
Nov. 15, 2024 (JP) 2024-200055

(51) Int. Cl. G01C 21/00

(52) U.S. Cl. CPC G01C 21/3841; G01C 21/3815

(57) ABSTRACT

A map generation device is configured to generate a probe map from probe data collected by a vehicle, and includes a processor configured to: acquire the probe data collected while the vehicle travel on a road; generate the probe map by combining the probe data with a base map including at least base shape information about a shape of the road; and correct the probe data based on a difference in shape between the base shape information and a probe shape information about the shape of the road estimated from probe behavior data related to behavior of the vehicle in the probe data. The generating of the probe map includes merging the corrected probe data onto the base map.

### CROSS REFERENCE TO RELATED APPLICATION

This application is based on Japanese Patent Application No. 2024-200055 filed on November 15, 2024, the disclosure of which is incorporated herein by reference.

### TECHNICAL FIELD

The present disclosure relates to map generation techniques to generate a probe map from probe data collected by a vehicle.

### BACKGROUND

A map data generating device generates map data based on probe data collected from vehicles. The map data generating device obtains difference data between the probe data and the basic map data.

### SUMMARY

According to an aspect of the present disclosure, a map generation device includes: at least one of (i) a circuit and (ii) a processor with a memory storing computer program code executable by the processor, the at least one of the circuit and the processor configured to cause the map generation device to: acquire probe data collected as a vehicle travels along a road; generate a probe map by combining the probe data with a base map including at least base shape information related to a shape of the road; and correct the probe data based on a difference in shape between the base shape information and probe shape information about the shape of the road estimated from probe behavior data, which is related to behavior of the vehicle and included in the probe data. The generating of the probe map may include merging the corrected probe data onto the base map.

### BRIEF DESCRIPTION OF DRAWINGS

FIG. 1 is a block diagram showing a map generation device for a vehicle according to an embodiment.

FIG. 2 is a schematic diagram illustrating a traveling environment of the vehicle.

FIG. 3 is a schematic diagram for explaining a base map in the embodiment.

FIG. 4 is a schematic diagram for explaining a probe map in the embodiment.

FIG. 5 is a schematic diagram for explaining a probe map in the embodiment.

FIG. 6 is a block diagram showing functional configuration of the map generation device in the embodiment.

FIG. 7 is a flowchart showing a map generation in the embodiment.

FIG. 8 is a schematic diagram showing a point cloud as probe data in the embodiment.

FIG. 9 is a graph showing data used in a correction process in the embodiment.

FIG. 10 is a graph showing data used in a correction process in another embodiment.

### DETAILED DESCRIPTION

A map data generating device generates map data based on probe data collected from vehicles. This map data generating device obtains difference data between the probe data and the basic map data. The map data generating device removes transient difference data by using a predetermined number of pieces of difference data or difference data accumulated for a predetermined period of time. The map data generating device generates map data based on the remaining difference data.

The map generating device needs to store the predetermined number of pieces of difference data or difference data accumulated for the predetermined period of time in order to distinguish the transient difference data. Therefore, it may take a long time to generate highly accurate map data.

The present disclosure provides a map generation device to generate highly accurate map data quickly. The present disclosure provides a map generation program to improve the accuracy of map data and reduce the time required for generating the map.

Hereinafter, technical means of the present disclosure for solving the problems will be described.

According to a first aspect of the present disclosure, a map generation device has a processor to generate a probe map from probe data collected by a vehicle. The processor is configured to: acquire probe data collected as a vehicle travels along a road; and generate a probe map by combining the probe data with a base map including at least base shape information related to a shape of the road. The processor is further configured to correct the probe data based on a difference in shape between the base shape information and probe shape information about the shape of the road estimated from probe behavior data related to behavior of the vehicle in the probe data. The corrected probe data is merged onto the base map to generate the probe map.

According to a second aspect of the present disclosure, a map generation method is to be executed by a processor to generate a probe map from probe data collected by a vehicle. The method includes: acquiring probe data collected as a vehicle travels along a road; and generating a probe map by combining the probe data with a base map including at least base shape information related to a shape of the road. The method further includes: correcting the probe data based on a difference in shape between the base shape information and probe shape information about the shape of the road estimated from probe behavior data related to behavior of the vehicle in the probe data. The corrected probe data is merged onto the base map to generate the probe map.

According to a third aspect of the present disclosure, a map generation program stored in a storage medium includes instructions to be executed by a processor to generate a probe map from probe data collected by a vehicle. The instructions include: acquiring probe data collected as a vehicle travels along a road; and generating a probe map by combining the probe data with a base map including at least base shape information related to a shape of the road. The instructions include: correcting the probe data based on a difference in shape between the base shape information and probe shape information about the shape of the road estimated from probe behavior data related to behavior of the vehicle in the probe data. The corrected probe data is merged onto the base map to generate the probe map.

Accordingly, the probe shape information of the probe data to be combined with the base map is corrected based on the base shape information of the base map. Since the base map is data that includes the base shape information, the need to store data for correcting the probe shape information is avoided. Therefore, the accuracy of the map data is improved and the time required for generating the map can be reduced.

Hereinafter, an embodiment of the present disclosure will be described with reference to the drawings.

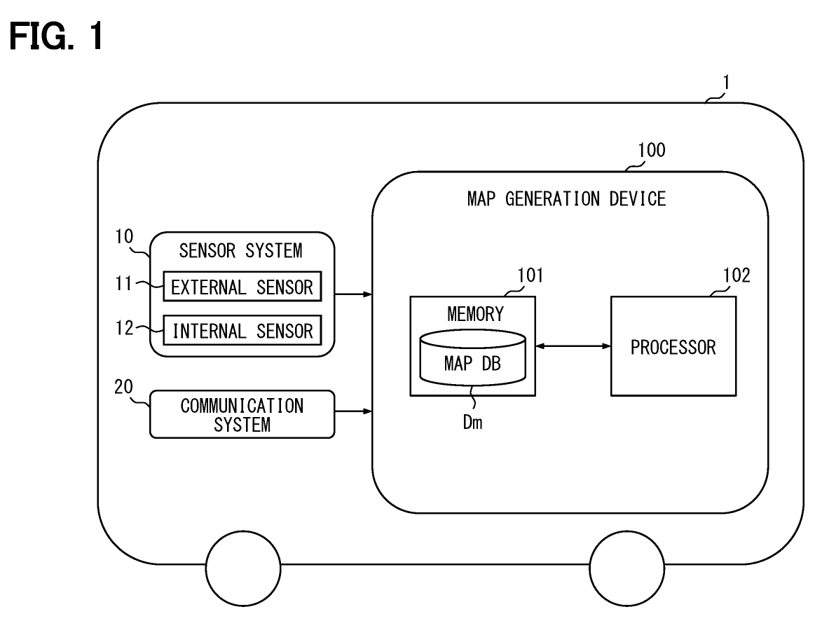

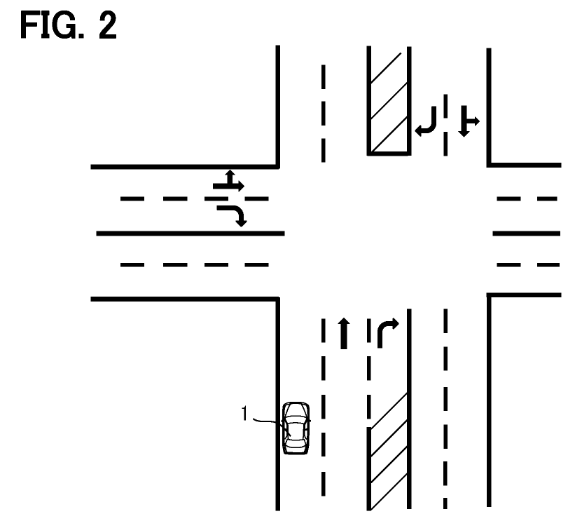

A map generation device 100 of an embodiment is shown in FIG. 1. The map generation device 100 generates a probe map Mp from probe data collected by a vehicle 1 shown in FIG. 2. From the viewpoint centered on the vehicle 1, the vehicle 1 can be referred to as a subject vehicle. The vehicle 1 is a mobile body such as an automobile that can travel on a road while an occupant is on the vehicle 1.

The vehicle 1 is provided with an automated driving mode that is divided into levels according to the degree of manual intervention by the occupant in the dynamic driving task. The automated driving mode may be achieved by autonomous driving control, where the system, when activated, performs all dynamic driving tasks. Autonomous driving control is realized, for example, by conditional driving automation, high-level driving automation, or full driving automation. The autonomous driving mode may be achieved by advanced driving assistance control, such as driving assistance or partial driving automation, in which the occupant performs some dynamic driving tasks. The autonomous driving mode may be realized by either one or combination of the automated driving control and the advanced driving assistance control or switching between the automated driving control and the advanced driving assistance control.

The vehicle 1 is equipped with a sensor system 10, a communication system 20, and a map database Dm shown in FIG. 1. The sensor system 10 acquires sensor information about the external and internal worlds of the vehicle 1 that can be used by the map generation device 100. The sensor system 10 includes an external sensor 11 and an internal sensor 12.

The external sensor 11 is configured to acquire external environment information as sensor information from the surroundings of the vehicle 1, which constitute the external environment. The external sensor 11 may be a target detection sensor that detects targets present in the external world of the vehicle 1. The external sensor 11 serving as a target detection sensor is at least one of a camera, LiDAR (Light Detection and Ranging/Laser Imaging Detection and Ranging), radar, sonar, and the like. The external sensor 11 may be of a positioning sensor that receives a positioning signal from an artificial satellite of a global navigation satellite system (i.e., GNSS) located in the external environment of the vehicle 1. The external sensor 11 serving as a positioning sensor is, for example, a GNSS receiver.

The internal sensor 12 is configured to acquire internal environment information as sensor information from the internal environment of the vehicle 1. The internal sensor 12 may be a physical quantity detection sensor that detects a specific physical quantity of motion within the internal environment of the vehicle 1. The internal sensor 12 as a physical quantity detection sensor is at least one type of sensor selected from a traveling speed sensor, an acceleration sensor, a gyro sensor, and the like. The internal sensor 12 may be an occupant detection sensor that detects a specific state of an occupant inside the vehicle 1. The internal sensor 12 serving as an occupant detection sensor is at least one of a Driver Status Monitor (registered trademark), a biological sensor, a seating sensor, an actuator sensor, and an in-vehicle equipment sensor. The map database Dm includes, as map information, at least a base map Mb that serves as the basis for a probe map Mp, which will be described later. The base map Mb is digital data that includes two-dimensional or three-dimensional topological information regarding the travel route of the vehicle. The topological information is data that indicates the relative connection relationships between the components along the road.

The communication system 20 acquires communication information usable by the map generation device 100 via wireless communication. The communication system 20 may also be of a V2X type that transmits and receives communication signals with a V2X system existing outside the vehicle 1. The V2X-type communication system 20 may be at least one type selected from among DSRC (Dedicated Short Range Communications) device and cellular V2X (C-V2X) communication device. The communication system 20 may be of a terminal communication type that transmits and receives communication signals with terminals existing inside the vehicle 1. The communication system 20 is, for example, a communication device that complies with a predetermined short-range wireless communication standard.

The map generation device 100 is communicably connected to the sensor system 10 and the communication system 20. The map generation device 100 is connected to the in-vehicle configuration via at least one of, for example, a LAN (Local Area Network) line, a wire harness, an internal bus, and a wireless communication line. The map generation device 100 includes at least one dedicated computer.

The dedicated computer that constitutes the map generation device 100 may be an integrated ECU (Electronic Control Unit) that integrates the driving control of the vehicle 1. The dedicated computer that constitutes the map generation device 100 may be a determination ECU that determines the driving task in driving control of the vehicle 1. The dedicated computer that constitutes the map generation device 100 may be a monitoring ECU that monitors the driving control of the vehicle 1. The dedicated computer that constitutes the map generation device 100 may be an evaluation ECU that evaluates the driving control of the vehicle 1.

The dedicated computer that constitutes the map generation device 100 may be a navigation ECU that navigates the travel route of the vehicle 1. The dedicated computer that constitutes the map generation device 100 may be a locator ECU that estimates the self-state quantity of the vehicle 1. The dedicated computer that constitutes the map generation device 100 may be an actuator ECU that controls the driving actuator of the vehicle 1. The dedicated computer constituting the map generation device 100 is an HCU (Human Machine Interface (HMI) Control Unit) that controls the presentation of information in the vehicle 1. The dedicated computer that constitutes the map generation device 100 may be a computer other than the vehicle 1. The computer other than the vehicle 1 is, for example, a computer that constitutes an external center or a mobile terminal that can communicate with the vehicle 1.

The dedicated computer that constitutes the map generation device 100 has at least one memory 101 and one processor 102. The memory 101 is a non-transitory tangible storage medium that non-temporarily stores computer-readable programs, data, and the like. For example, the memory 101 is at least one of a semiconductor memory, a magnetic medium, an optical medium, and the like. The memory 101 stores a map generation program for generating a probe map Mp from the probe data collected by the vehicle 1.

The memory 101 stores the map database Dm in a part of its storage area. The map database Dm contains map information that can be used in the map generation method. The memory 101 that stores the map database Dm may be a storage medium for a locator that estimates the vehicle's own state quantities including its own position. The memory 101 that stores the map database Dm may be a storage medium of a navigation unit that navigates the travel route of the vehicle 1. The memory 101 that stores the map database Dm may be configured by combining plural types of these storage media.

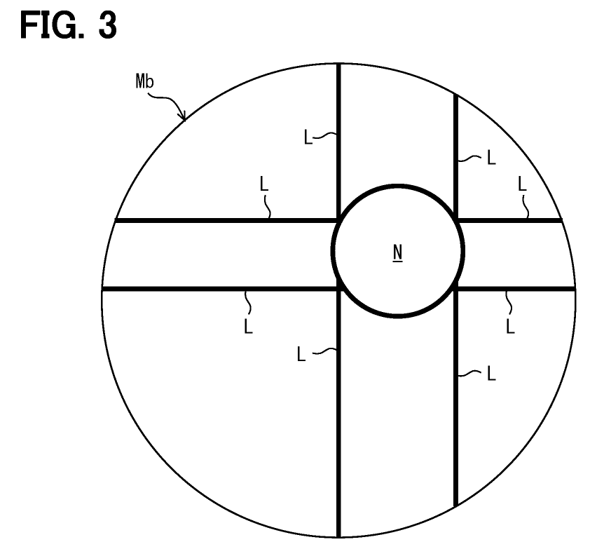

Specifically, as shown in FIG. 3, the base map Mb defines a travel route by nodes N and links L connecting the nodes N. The node N defines a point where, for example, multiple roads are connected. The node N is at least one type of node, such as an intersection, a junction, or a branch point. The node N may define the start and end points of a curved section in the road. The nodes N may be included in one or more points between the start and the end of the curved section. The base map Mb includes, for example, the position information and type information of each node N.

The link L defines the road between the nodes N. The link L may define the left and right boundaries of the road, or may define the road as a single line segment. The base map Mb includes, for example, identification information of the node N to which each link L is connected. The base map Mb includes curvature information of the link L corresponding to the curved section. Alternatively, the base map Mb may define the curved section by the plural nodes N set within the curved section and the straight link L connecting the nodes N. The base map Mb may include information such as the width and number of lanes of each link L.

The base map Mb defines the travel route by abstracting it into a graph structure using the nodes N and the links L. The information about the nodes N and the links L is an example of base shape information. The base map Mb is written in at least one of a text map format and a graphical map format, for example. The base map Mb may be stored in the memory 101, for example, at the time of shipping from the factory. Alternatively, the base map Mb may be acquired by distribution or the like after shipping from the factory and stored in the memory 101. The base map Mb is used for route guidance in the navigation function, for example.

In the map database Dm, the probe data collected by the vehicle 1 is merged with the base map Mb to generate a probe map Mp. The probe map Mp is data with a hierarchical structure including a base layer based on the base map Mb and a probe layer onto which the probe data is mapped.

The probe map Mp may include road information that indicates at least one of the following: the position, shape, and road surface condition of the road itself. The probe map Mp may include marking information that indicates at least one of the positions and shapes of road signs and road markings, for example. The map information may include structure information representing at least one type among the position and shape of buildings and traffic signals facing the road.

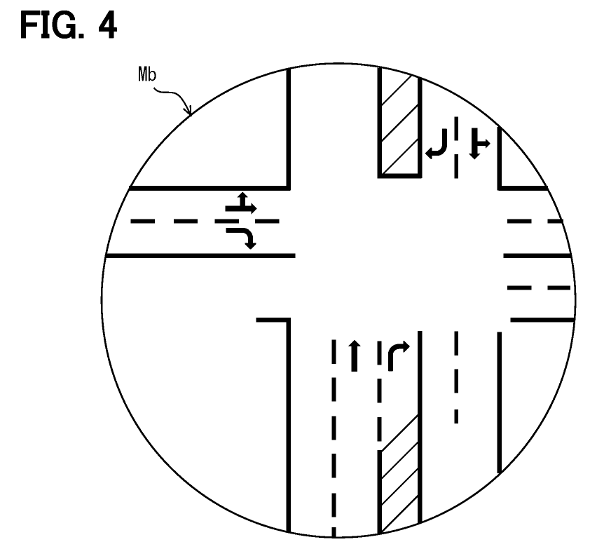

The probe map Mp is updated every time a vehicle travels, that is, every time new probe data is collected. FIGS. 4 and 5 show examples of the probe map Mp relating to the same area as the base map Mb of FIG. 3. FIG. 5 shows an updated version of the probe map Mp of FIG. 4. As shown in FIGS. 4 and 5, the amount of information in the probe map Mp can be increased by updating.

The processor 102 includes at least one type of core, such as a CPU (Central Processing Unit), GPU (Graphics Processing Unit), RISC-CPU (Reduced Instruction Set Computer CPU), CISC-CPU (Complex Instruction Set Computer CPU), DFP (Data Flow Processor), or GSP (Graph Streaming Processor).

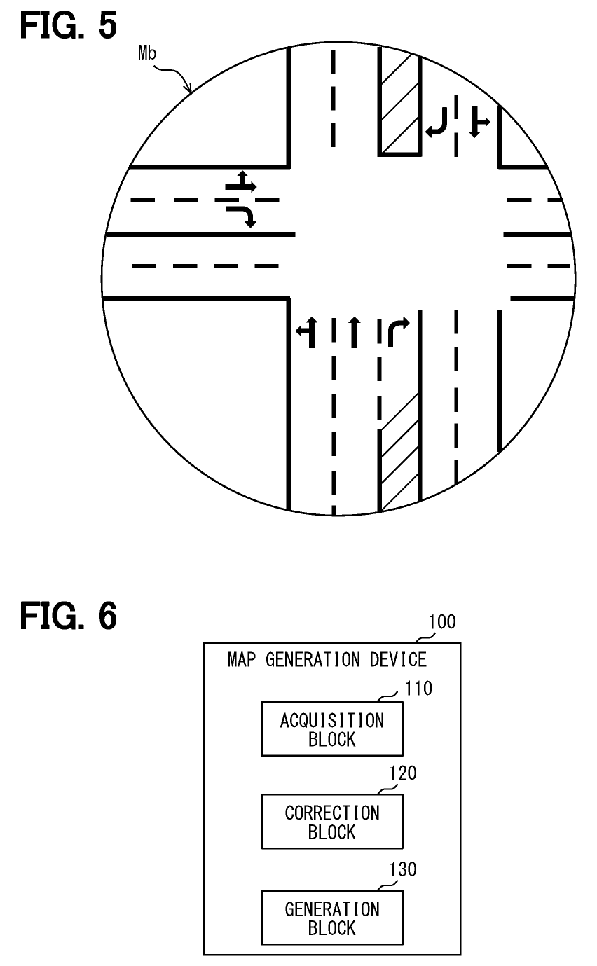

In the map generation device 100, the processor 102 executes plural instructions contained in a map generating program stored in the memory 101. As a result, the map generation device 100 includes multiple functional blocks for generating a probe map. As shown in FIG. 6, the functional blocks in the map generation device 100 include an acquisition block 110, a correction block 120, and a generation block 130.

The acquisition block 110 acquires probe data collected by the sensor system 10 of the vehicle 1. The acquisition block 110 acquires probe data collected by traveling a specific travel section. The travel section is, for example, from the departure point of the vehicle 1 to the destination point. The probe data includes probe target data relating to targets in the external world of the vehicle 1, acquired by the external sensor 11 or the like. The target includes road markings such as lane lines, stop lines, and pedestrian crossings. Furthermore, the target includes road installations such as traffic lights, road signs, and curbs, as well as buildings facing the road. The acquisition block 110 acquires the probe target data as, for example, a point cloud Pc including at least relative position information with respect to the vehicle 1. The acquisition block 110 may acquire data on dynamic targets such as other vehicles and pedestrians as probe target data in addition to the static targets described above.

Furthermore, the probe data includes probe behavior data regarding the behavior of the vehicle 1 acquired by the internal sensor 12 or the like. The behavior is at least one of, for example, yaw rate, speed, acceleration, jerk, attitude angle, steering angle, and self-position. The acquisition block 110 acquires the probe behavior data as, for example, time-series data accompanying driving. In this embodiment, the probe data is collected by a single vehicle 1.

The correction block 120 corrects the probe data using the base map Mb. Specifically, the correction block 120 compares probe shape information of the road estimated from the probe behavior data in the probe data, with the base shape information of the road based on the base map Mb. Then, the correction block 120 calculates the shape error of the probe shape information relative to the base shape information. The correction block 120 corrects the probe behavior data by correcting the shape error that falls outside a set range. Furthermore, the correction block 120 corrects the position information of the probe target data, which is mapped based on the probe behavior data, based on the corrected probe behavior data. The shape information of the road used for correction is, for example, curvature information of the road.

The generation block 130 generates a probe map Mp from the probe data and the base map Mb. Specifically, the generation block 130 maps the collected probe data. The generation block 130 merges the mapped probe data that does not require correction or has been corrected into the base map Mb as a layer separate from the base map Mb. As a result, the generation block 130 generates a probe map Mp having a hierarchical structure.

The generation block 130 integrates the probe data acquired during the second or subsequent travel of the same travel road section with the probe data from the previous travel time and combines it into the base map Mb. In this way, the generation block 130 updates the probe map Mp every time the vehicle travels. The generation block 130 stores the generated and updated probe map Mp in a storage medium such as the memory 101. The stored probe map Mp is used, for example, for generating a trajectory in an automatic driving operation. Alternatively, the generation block 130 may transmit the generated probe map Mp to an external device such as a center or another vehicle.

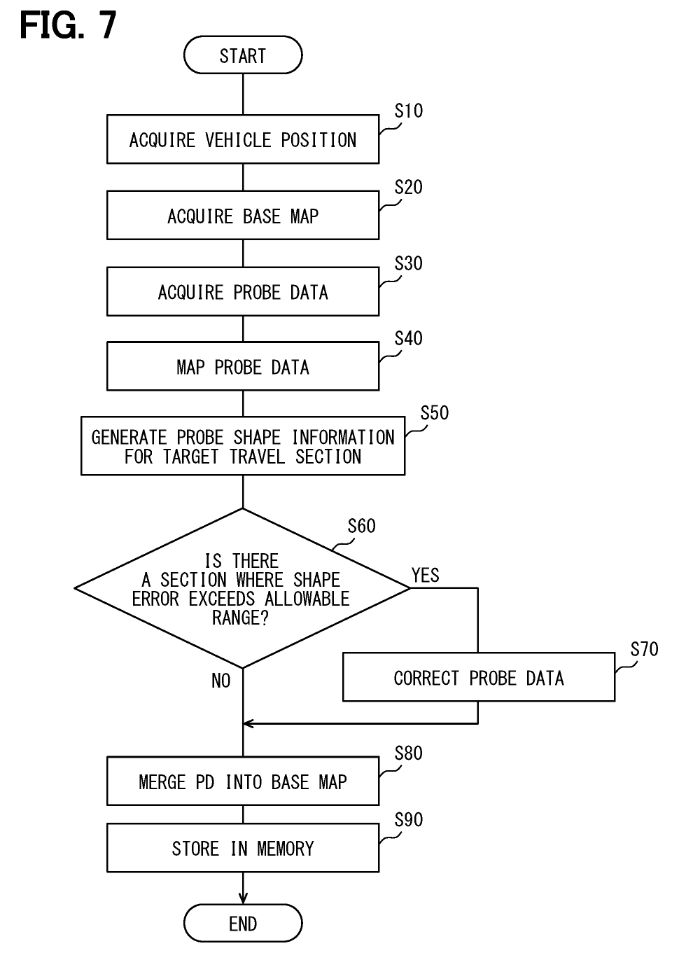

The map generating method in which the map generation device 100 generates the probe map Mp through cooperation of the acquisition block 110, the correction block 120, and the generation block 130 is executed according to the map generating flow shown in FIG. 7. This map generation flow is repeatedly executed while the vehicle 1 is running. Each "S" in this map generation flow represents steps executed by plural commands included in the map generation program.

In S10, the acquisition block 110 acquires the position information of the vehicle 1 that is running. In S20, the acquisition block 110 acquires a base map Mb relating to the road around the position of the vehicle 1. The acquisition block 110 acquires the base map Mb by reading the base map Mb of the relevant area from the memory 101.

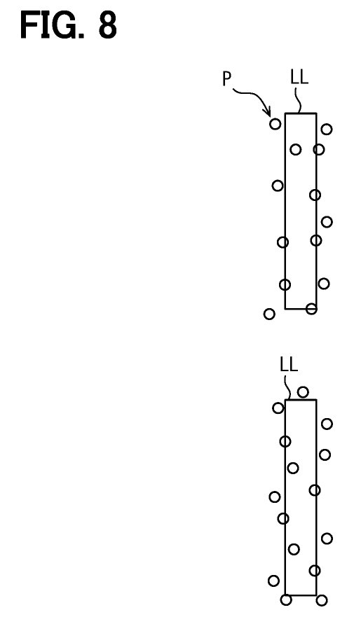

In S30, the acquisition block 110 acquires the probe data collected by the sensor system 10 during the current travel. In S40, the generation block 130 maps the probe data. Specifically, the generation block 130 converts the position information of the probe target data of the probe data into position information in a map coordinate system based on the probe behavior data. As a result, the generation block 130 generates mapped probe data representing various targets using the point cloud P including position information based on a map coordinate system. FIG. 8 shows examples of the point cloud P that is mapped for lane markings LL of the road. Due to noise when the sensor system 10 collects the probe behavior data, the position of the point cloud P may be shifted from the actual lane marking LL. The mapping of the probe data may be performed at any time during the journey or after arrival at the destination.

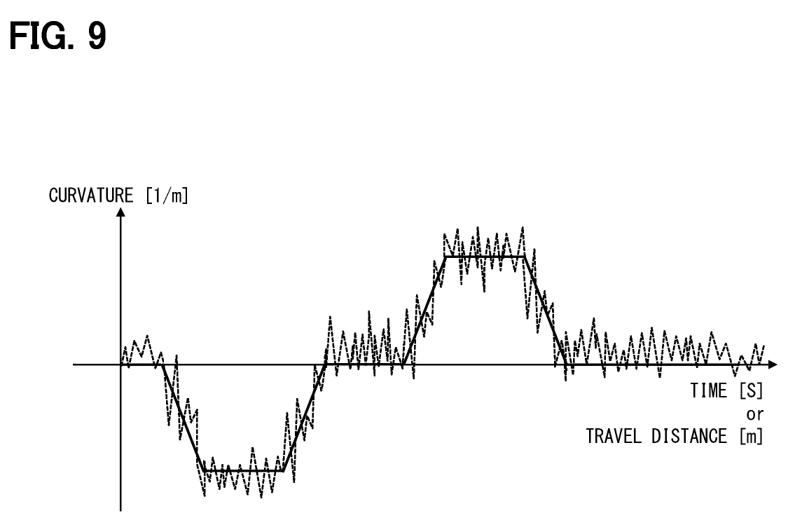

In S50, the correction block 120 generates probe shape information for the target travel section for which the probe map Mp is to be generated. The probe shape information is, for example, probe curvature information as indicated by the dashed line in FIG. 9. Since the curvature is a value correlated with the yaw rate, the correction block 120 generates, as probe curvature information, a time-series curvature calculated from the time-series yaw rate in the probe behavior data. As shown in FIG. 9, the probe shape information is likely to contain relatively high frequency noise. On the other hand, the base shape information for the probe shape information is data that is less likely to contain high frequency components, as shown by the solid line in FIG. 9.

In S60, the correction block 120 determines whether there is a section in which the shape error is outside the set allowable range. Specifically, the correction block 120 calculates a curvature error, which is an error relative to the base curvature information, of the probe curvature information at each point. Then, the correction block 120 determines whether there is a section (point) where the curvature error is outside the set allowable range, in which the curvature error is equal to or less than the upper threshold value.

When the curvature of a link L is included in the base map Mb, the base curvature information is the curvature of the link L in the target section. When a curved road is described by a node N and a straight link L in the base map Mb, the base curvature information is a curvature approximately calculated from the node N and the link L.

When it is determined that there is a section in which the difference is outside the set range, the flow proceeds to S70. In S70, the correction block 120 corrects the probe data for the section where the curvature difference is outside the set range. For example, the correction block 120 corrects the probe curvature information. The correction block 120 may correct the probe curvature information by simply subtracting the curvature error from the probe curvature information. Alternatively, the correction block 120 may correct the probe curvature information using filtering such as a Kalman filter. Then, the correction block 120 corrects the probe behavior data based on the corrected probe curvature information. In this embodiment, the correction block 120 corrects the yaw rate. Furthermore, the correction block 120 corrects the position information and the like of the mapped probe target data based on the corrected probe behavior data.

The correction block 120 stops correction for probe data at a point where the curvature difference falls outside an allowable range whose upper limit is greater than the upper limit of the set range. The allowable range is a range in which the curvature difference is equal to or less than an upper threshold value that is greater than the upper threshold value of the set range.

In S80, the generation block 130 generates a probe map Mp by merging the probe data (PD) into the base map Mb. Specifically, the generation block 130 associates the mapped probe data that does not require correction or has been corrected with the base layer as a layer separate from the base layer. As a result, the generation block 130 generates a probe map Mp that is configured from the base map Mb and the hierarchical structure of the probe data.

When the vehicle has traveled through the probe data collection section for the second or subsequent time, the generation block 130 generates integrated probe data by integrating the probe data from multiple times. For example, the integrated probe data is obtained by averaging the position information of features for each number of trips. The generation block 130 merges the integrated probe data into a

probe map Mp. That is, the generation block 130 updates the probe map Mp every time the same collection section is traveled.

Furthermore, in the merging process, the generation block 130 reduces the contribution of probe data whose curvature difference falls outside the allowable range to the probe map Mp compared to probe data whose curvature difference falls within the allowable range. Specifically, the generation block 130 may exclude probe data that falls outside the allowable range in merging, thereby setting the contribution of the data to zero. Alternatively, the generation block 130 may assign a weight to probe data that falls outside the set range as a contribution when generating the integrated probe data. In this case, the weight of the probe data that falls outside the acceptable range is set lower than the weight of the probe data that falls within the acceptable range. It should be noted that a weight according to the shape difference may also be set for the probe data that falls within the set range.

The generation block 130 may suspend generation of the probe map Mp relating to the same collection section until probe data for the collection section has been acquired a set number of times. The set number of travel times is, for example, the number of travel times at which it can be determined that the collected probe data can be used for purposes such as autonomous driving.

In S90, the generation block 130 stores the generated probe map Mp in the memory 101. The stored probe map Mp is used in automated driving and the like.

According to the embodiment, when the probe data is combined with the base map Mb, the difference is corrected using information about the shape of the road. Therefore, the accuracy of the probe map Mp is improved based on the already existing base map Mb. Therefore, highly accurate map data can be improved at an early stage. In particular, by using a global map such as a map in a navigation function as the base map Mb, it becomes easier to remove high frequency noise from the probe data.

Furthermore, according to the embodiment, the curvature information is used as the probe shape information and the base shape information. Therefore, it is possible to correct the probe data based on the curve shape of the road.

Furthermore, according to the embodiment, the correction is stopped when the degree of deviation between the base shape information and the probe shape information falls outside the allowable range. When the degree of deviation is large, there is a possibility that the shape error of the base map Mb relative to the actual road may be large. Therefore, it is possible to avoid large errors from occurring relative to the actual shape by cancelling the correction of probe data based on the base map Mb with a large shape error, when the degree of deviation is large.

In addition, according to the embodiment, the probe map Mp, which is generated by integrating probe data collected over different time periods, can be generated accurately and quickly.

Furthermore, according to the embodiment, a highly accurate probe map Mp can be generated quickly from probe data collected from a single vehicle 1. Therefore, when a map generation method that may take more time than collecting probe data from multiple vehicles 1 is used, the time required to generate a highly accurate probe map Mp can be shortened.

The above describes one embodiment, however, the present disclosure is not to be construed as being limited to the described embodiment, and can be applied to various embodiments without departing from the spirit and scope of the present disclosure.

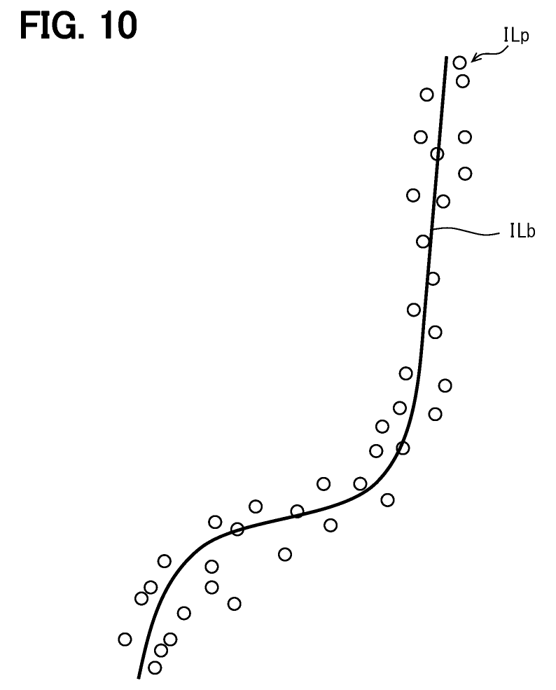

In a modified example, the map generation device 100 may use vehicle position information as road shape information, as shown in FIG. 10. That is, the map generation device 100 may correct the probe data by correcting the error at each point of the probe position information ILp as probe shape information relative to the base position information ILb as base shape information.

In a modified example, the map generation device 100 may acquire probe data of other vehicles and integrate the data with the probe data of the subject vehicle.

In a modified example, the dedicated computer that constitutes the map generation device 100 may have at least one of a digital circuit and an analog circuit as a processor. Here, the digital circuit refers to at least one type among, for example, an ASIC (Application Specific Integrated Circuit), FPGA (Field Programmable Gate Array), SoC (System on a Chip), PGA (Programmable Gate Array), and CPLD (Complex Programmable Logic Device). The digital circuit may include a memory storing a program.

In a modified example, the vehicle 1 to which the map generation device 100 is applied may be an autonomous robot capable of transporting luggage or collecting information by autonomous driving or remote driving, for example. An autonomous robot may also be referred to as an autonomous vehicle.

What is claimed is:

1. A map generation device configured to generate a probe map from probe data collected by a vehicle, the map generation device comprising:
at least one of (i) a circuit and (ii) a processor with a memory storing computer program code executable by the processor, the at least one of the circuit and the processor configured to cause the map generation device to:
acquire the probe data collected while the vehicle travels on a road;
generate the probe map by combining the probe data with a base map including at least base shape information about a shape of the road; and
correct the probe data based on a difference in shape between the base shape information and probe shape information about the shape of the road estimated from probe behavior data, which is related to behavior of the vehicle and included in the probe data, wherein
the generating of the probe map includes merging the corrected probe data onto the base map.

2. The map generation device according to claim 1, wherein
the correcting of the probe data includes correcting the probe data based on a difference in curvature information between the road estimated from the probe behavior data and the road included in the base map.

3. The map generation device according to claim 1, wherein
the generating of the probe map includes reducing a contribution of the probe data to the probe map when the difference in shape between the probe shape information and the base shape information falls outside an allowable range.

4. The map generation device according to claim 1, wherein
the generating of the probe map includes integrating the probe data obtained by traveling a same road in different time periods to combine the probe data with the base map.

5. The map generation device according to claim 1, wherein
the generating of the probe map includes combining the probe data collected by a single vehicle with the base map.

6. A map generation method executed by a processor to generate a probe map from probe data collected by a vehicle, comprising:
acquiring the probe data collected while the vehicle travels on a road;
generating the probe map by combining the probe data with a base map including at least base shape information about a shape of the road; and
correcting the probe data based on a difference in shape between the base shape information and probe shape information about the shape of the road estimated from probe behavior data, which is related to behavior of the vehicle and included in the probe data, wherein
the generating of the probe map includes merging the corrected probe data onto the base map.

7. A map generation program product stored in a non-transitory storage medium and including instructions to be executed by a processor to generate a probe map from probe data collected by a vehicle, comprising:
acquiring the probe data collected while the vehicle travels on a road;
generating the probe map by combining the probe data with a base map including at least base shape information about a shape of the road; and
correcting the probe data based on a difference in shape between the base shape information and probe shape information about the shape of the road estimated from probe behavior data, which is related to behavior of the vehicle and included in the probe data, wherein
the generating of the probe map includes merging the corrected probe data onto the base map.
